(19) United States
(12) Patent Application Publication
(10) Pub. No.: US 2025/0310927 A1
(43) Pub. Date: Oct. 2, 2025

(54) TERMINAL, BASE STATION, RADIO COMMUNICATION SYSTEM AND RADIO COMMUNICATION METHOD

(71) Applicant: NTT DOCOMO, INC., Tokyo (JP)

(72) Inventors: Shohei Yoshioka, Tokyo (JP); Satoshi Nagata, Tokyo (JP); Luhua You, Beijing (CN); Weiqi Sun, Beijing (CN); Jing Wang, Beijing (CN); Lan Chen, Beijing (CN); Jinming Zhao, Beijing (CN); Yong Li, Beijing (CN)

(73) Assignee: NTT DOCOMO, INC., Tokyo (JP)

(21) Appl. No.: 18/867,296

(22) PCT Filed: May 24, 2022
(86) PCT No.: PCT/JP2022/021312

§ 371 Date: Nov. 19, 2024

(51) Int. Cl. H04W 64/00; H04L 5/00; H04W 24/10; H04W 84/06

(52) U.S. Cl. CPC H04W 64/00; H04L 5/0051; H04W 24/10; H04W 84/06

(57) ABSTRACT

A terminal comprising: a reception unit that receives two or more downlink reference signals at different timings on a time axis from a single non-terrestrial network device via a non-terrestrial network; and control unit that controls a reporting of measurement results related to each of the two or more downlink reference signals in a specific control for estimating position information of the terminal based on the two or more downlink reference signals.

### TECHNICAL FIELD

This disclosure relates to a terminal, a base station, a radio communication system, and a radio communication method for estimating position information of the terminal.

### BACKGROUND ART

The 3rd Generation Partnership Project (3GPP) has specified the 5th generation mobile communication system (Also called 5G, New Radio (NR) or Next Generation (NG)) and is also proceeding with the next generation specifications called Beyond 5G, 5G Evolution or 6G.

The 3GPP specifies technology for estimating position information of a terminal (hereinafter referred to as UE; User Equipment) using techniques such as Multi-RTT (Round Trip Time), DL-TDOA (Downlink Time Difference of Arrival) and UL-TDOA (Uplink Time Difference of Arrival) (For example, Non-Patent Literature 1).

In addition, NTN (Non-Terrestrial Network) is under consideration in 3GPP. NTN provides services to areas that cannot be covered by terrestrial networks due to cost and other reasons by using non-terrestrial networks such as artificial satellites (hereinafter satellite).

### CITATION LIST

### Non-Patent Literature

### [Non-Patent Literature 1]

3GPP TS38.305 V17.0.0 March 2022

### SUMMARY OF INVENTION

Techniques such as Multi-RTT, DL-TDOA, and UL-TDOA are based on the premise of communication between multiple (preferably 3 or more) TRPs (Transmission-Reception Points) and UEs.

Under such a background, the inventors and others have found, as a result of intense study, that it is assumed that it is difficult to capture a plurality of TRPs (For example, a satellite relaying between a base station and a UE) in an NTN.

It is therefore an object of the present invention to solve the above-described problem, and to provide a terminal, a base station, a radio communication system, and a radio communication method capable of appropriately estimating position information of a terminal using a single TRP.

An aspect of the disclosure is a terminal comprising: a reception unit that receives two or more downlink reference signals at different timings on a time axis from a single non-terrestrial network device via a non-terrestrial network; and a control unit that controls a reporting of measurement results related to each of the two or more downlink reference signals in a specific control for estimating position information of the terminal based on the two or more downlink reference signals.

An aspect of the disclosure is a base station comprising: a reception unit that receives two or more uplink reference signals at different timings on a time axis from a single non-terrestrial network device via a non-terrestrial network; and a control unit that controls a reporting of measurement results related to each of the two or more downlink reference signals in a specific control for estimating position information of the terminal based on the two or more downlink reference signals.

An aspect of the disclosure is a radio communication system comprising: a terminal; and a base station; wherein at least one node of the terminal and the base station comprises: a reception unit that receives two or more uplink reference signals at different timings on a time axis from a single non-terrestrial network device via a non-terrestrial network; and a control unit that controls a reporting of measurement results related to each of the two or more downlink reference signals in a specific control for estimating position information of the terminal based on the two or more downlink reference signals.

An aspect of the disclosure is a radio communication method comprising: receiving two or more uplink reference signals at different timings on a time axis from a single non-terrestrial network device via a non-terrestrial network; and controlling porting of measurement results related to each of the two or more downlink reference signals in a specific control for estimating position information of the terminal based on the two or more downlink reference signals.

### BRIEF DESCRIPTION OF DRAWINGS

FIG. 1 is an overall schematic diagram of the radio communication system 10.

FIG. 2 is a diagram showing frequency ranges used in the radio communication system 10.

FIG. 3 is a diagram showing an example configuration of radio frames, sub-frames and slots used in the radio communication system 10.

FIG. 4 is a functional block diagram of the UE200.

FIG. 5 is a functional block diagram of the gNB100.

FIG. 6 is a functional block diagram of the LMF300.

FIG. 7 is a diagram for explaining a protocol.

FIG. 8 is a diagram for explaining an outline of an operation example.

FIG. 9 is a diagram for explaining operation example 1.

FIG. 10 are views for explaining operation example 2.

FIG. 11 are views for explaining operation example 2.

FIG. 12 are views for explaining operation example 3.

FIG. 13 are views for explaining operation example 4.

FIG. 14 are views showing an example of the hardware configuration of the gNB100 and the UE200.

FIG. 15 are views showing an example of the configuration of vehicle 2001.

### DESCRIPTION OF EMBODIMENT

Exemplary embodiments of the present invention are explained below with reference to the accompanying drawings. It should be noted that the same functions and configurations are denoted by the same or similar reference numerals, and the description thereof will be omitted as appropriate.

### Embodiment

### (1) Overall Schematic Configuration of the Radio Communication System

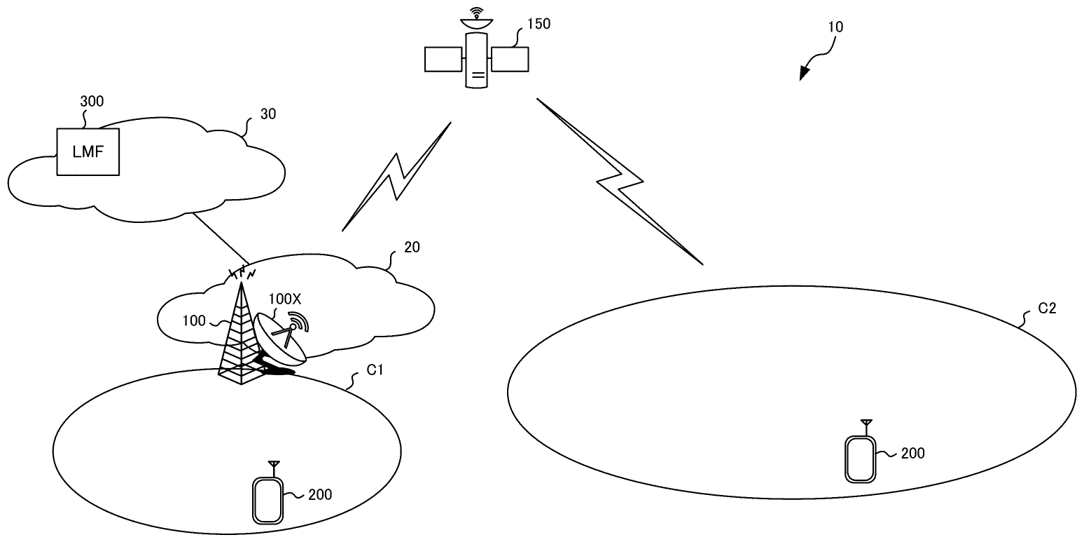

FIG. 1 is an overall schematic diagram of a radio communication system 10 according to an embodiment. The radio communication system 10 is a radio communication system according to the 5G New Radio (NR), and includes a Next Generation-Radio Access Network 20 (hereinafter, NG-RAN 20) and a terminal 200 (UE (User Equipment) 200).

The radio communication system 10 may be a radio communication system according to a system called Beyond 5G, 5G Evolution, or 6G.

The NG-RAN20 includes a base station 100 (hereinafter gNB100). A specific configuration of the radio communication system 10 including the number of gNBs 100 and UEs 200 is not limited to the example shown in FIG. 1.

The NG-RAN20 actually includes a plurality of NG-RAN Nodes, specifically, gNBs (or ng-eNBs), and is connected to the core network 30 according to 5G (For example, 5 GC). The NG-RAN20 and the core network 30 may be simply described as a “network”.

The gNB100 is a radio base station according to 5G, and executes radio communication according to the UE200 and 5G. The gNB100 and the UE200 can support Massive MIMO (Multiple-Input Multiple-Output), which generates a beam BM with higher directivity by controlling radio signals transmitted from a plurality of antenna elements, Carrier Aggregation (CA), which uses a plurality of component carriers (CC) bundled together, and Dual Connectivity (DC), which simultaneously communicates with two or more transport blocks between the UE and each of the two NG-RAN Nodes.

The core network 30 includes a network device 300. The network device 300 may include LMF (Location Management Function). The network device 300 may include an AMF (Access and Mobility management Function). The network device 300 may be an E-SMLC (Evolved Serving Mobile Location Centre). In the following, a case where the network device 300 is an LMF300 will be mainly described.

In the embodiment, a non-terrestrial network (hereinafter referred to as NTN; Non-Terrestrial Network) is assumed. In the NTN, a non-terrestrial network such as the satellite 150 (hereinafter satellite 150) is used to provide services to areas that cannot be covered by the terrestrial network (hereinafter TN) due to cost or other reasons. The NTN can provide more reliable services. For example, the NTN is assumed to be applied to IoT (Inter of things), ships, buses, trains, and critical communications. The NTN also has scalability by efficient multicast or broadcast. Note that a network including the gNB100 and the UE200 without including the satellite 150 may be called a terrestrial network (TN) in contrast to the NTN.

The gNB100 has an NTN gateway 100X. The NTN gateway 100X transmits a downlink signal to the satellite 150. The NTN gateway 100X receives an uplink signal from the satellite 150. The gNB100 has a cell C1 as a coverage area.

The satellite 150 relays a downlink signal received from the NTN gateway 100X to the UE200. Satellite 150 relays uplink signals received from UE200 to NTN gateway 100X. Satellite 150 has cell C2 as a coverage area. Satellite 150 may be considered as a transmission-reception point (TRP).

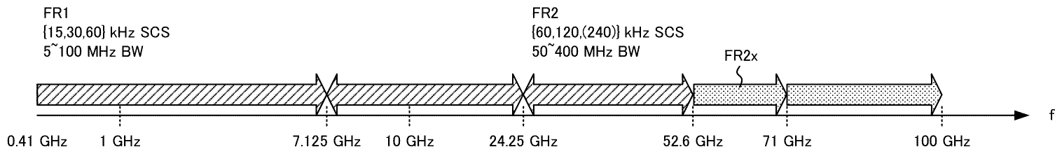

The radio communication system 10 supports multiple frequency ranges (FR). FIG. 2 shows the frequency ranges used in the radio communication system 10.

As shown in FIG. 2, the radio communication system 10 supports FR1 and FR2. The frequency bands of each FR are as follows.
FR1: 410 MHz˜7.125 GHz.
FR2: 24.25 GHz˜52.6 GHz

FR1 uses Sub-Carrier Spacing (SCS) of 15, 30, or 60 kHz, and may use a bandwidth (BW) of 5˜100 MHz. FR2 has a higher frequency than FR1, and uses SCS of 60, or 120 kHz (240 kHz may be included), and may use a bandwidth (BW) of 50˜400 MHz.

SCS may be interpreted as numerology. Numerology is defined in 3GPP TS38.300, and corresponds to one sub-carrier spacing in the frequency domain.

Furthermore, the radio communication system 10 corresponds to a higher frequency band than FR2. Specifically, the radio communication system 10 corresponds to a frequency band exceeding 52.6 GHz and up to 71 GHz or 114.25 GHz. Such a high frequency band may be called “FR 2×” for convenience.

In order to solve the problem that the influence of phase noise increases in the high frequency band, when a band exceeding 52.6 GHz is used, Cyclic Prefix-Orthogonal Frequency Division Multiplexing (CP-OFDM)/Discrete Fourier Transform-Spread (DFT-S-OFDM) with a larger Sub-Carrier Spacing (SCS) may be applied.

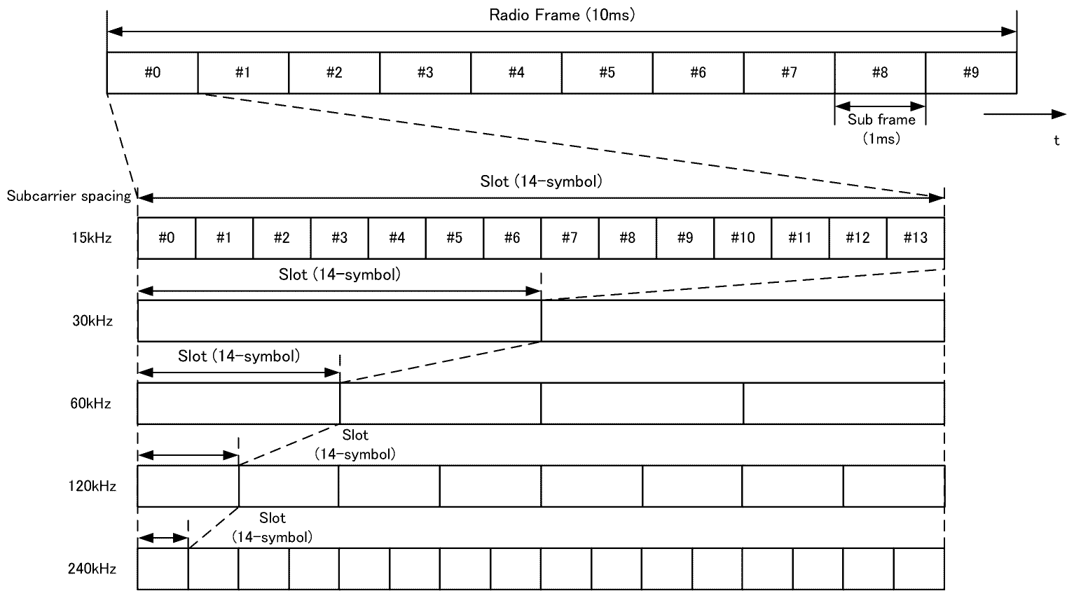

FIG. 3 shows a configuration example of a radio frame, a sub-frame, and a slot used in the radio communication system 10.

As shown in FIG. 3, 1 slot is composed of 14 symbols, and the larger (wider) the SCS, the shorter the symbol period (and slot period). The SCS is not limited to the interval (frequency) shown in FIG. 3. For example, 480 kHz or 960 kHz may be used.

The number of symbols constituting 1 slot may not necessarily be 14 symbols (E.G., 28 symbols, 56 symbols). Furthermore, the number of slots per subframe may be different depending on the SCS.

Note that the time direction (t) shown in FIG. 3 may be called a time domain, a symbol period, or a symbol time. The frequency direction may be called a frequency domain, a resource block, a subcarrier, a bandwidth part (BWP), or the like.

The DMRS is a type of reference signal and is prepared for various channels. Here, unless otherwise specified, it may mean a DMRS for a downlink data channel, specifically, a PDSCH (Physical Downlink Shared Channel). However, the DMRS for an uplink data channel, specifically, a PUSCH (Physical Uplink Shared Channel), may be interpreted the same as the DMRS for a PDSCH.

The DMRS may be used for channel estimation in the UE200 as part of a device, e.g., coherent demodulation. The DMRS may reside only in the resource block (RB) used for PDSCH transmission.

The DMRS may have multiple mapping types. Specifically, the DMRS may have Mapping Type A and Mapping Type B. In Mapping Type A, the first DMRS may be placed on the second or third symbol of the slot. In Mapping Type A, the DMRS may be mapped relative to the slot boundary regardless of where the actual data transmission begins in the slot. The reason for placing the first DMRS on the second or third symbol of the slot may be interpreted as placing the first DMRS after the control resource sets (CORESET).

In Mapping Type B, the first DMRS may be placed on the first symbol of the data allocation. That is, the position of the DMRS may be given relative to the location where the data is located, rather than relative to the slot boundary.

The DMRS may have a plurality of types. Specifically, the DMRS may have types 1 and 2. Types 1 and 2 differ in the maximum number of mapping and orthogonal reference signals in the frequency domain. Type 1 is a single-symbol DMRS capable of outputting up to 4 orthogonal signals, and Type 2 is a double-symbol DMRS capable of outputting up to 8 orthogonal signals.

### (2) Function Block Configuration of Radio Communication System

Next, the functional block configuration of the radio communication system 10 will be described.

First, a functional block configuration of the UE200 will be described.

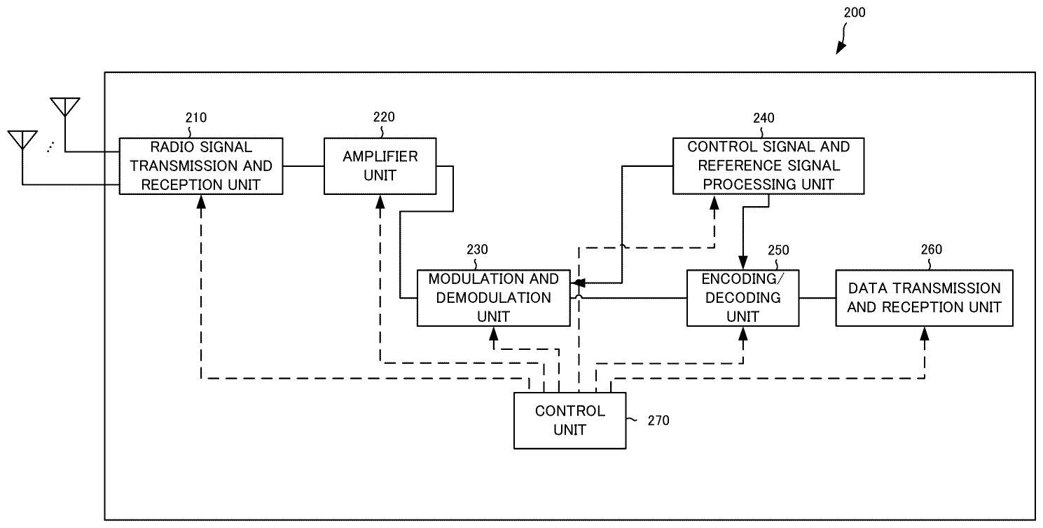

FIG. 4 is a functional block configuration diagram of the UE200. As shown in FIG. 4, the UE200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

The radio signal transmission and reception unit 210 transmits and receives radio signals according to NR. The radio signal transmission and reception unit 210 corresponds to a Massive MIMO, a CA that uses a plurality of CCs bundled together, and a DC that simultaneously communicates between the UE and each of the two NG-RAN Nodes.

The amplifier unit 220 includes PA (Power Amplifier), LNA (Low Noise Amplifier), and the like. The amplifier unit 220 amplifies the signal output from the modulation and demodulation unit 230 to a predetermined power level. The amplifier unit 220 amplifies the RF signal output from the radio signal transmission and reception unit 210.

The modulation and demodulation unit 230 executes data modulation/demodulation, transmission power setting, resource block allocation, and the like for each predetermined communication destination (gNB100 or another gNB). In the modulation and demodulation unit 230, Cyclic Prefix-Orthogonal Frequency Division Multiplexing (CP-OFDM)/Discrete Fourier Transform-Spread (DFT-S-OFDM) may be applied. The DFT-S-OFDM may be used not only for the uplink (UL) but also for the downlink (DL).

The control signal and reference signal processing unit 240 executes processes related to various control signals transmitted and received by the UE200 and processes related to various reference signals transmitted and received by the UE200.

Specifically, the control signal and reference signal processing unit 240 receives various control signals transmitted from the gNB 100 via a predetermined control channel, for example, a radio resource control layer (RRC) control signal. The control signal and reference signal processing unit 240 transmits various control signals to the gNB100 via a predetermined control channel.

The control signal and reference signal processing unit 240 executes processing using a reference signal (RS) such as a demodulation reference signal (DMRS) and a phase tracking reference signal (PTRS).

The DMRS is a reference signal (pilot signal) known between the base station and the terminal for each terminal for estimating a fading channel to be used for data demodulation. The PTRS is a reference signal for each terminal for estimating phase noise which is a problem in a high frequency band.

In addition to the DMRS and the PTRS, the reference signal may include a channel state information-reference signal (CSI-RS), a sounding reference signal (SRS), and a positioning reference signal (PRS) for position information.

The channel includes a control channel and a data channel. The control channel includes a PDCCH (Physical Downlink Control Channel), a PUCCH (Physical Uplink Control Channel), a RACH (Random Access Channel), a Downlink Control Information (DCI) including a Random Access Radio Network Temporary Identifier (RA-RNTI), and a Physical Broadcast Channel (PBCH).

The data channel includes PDSCH (Physical Downlink Shared Channel), PUSCH (Physical Uplink Shared Channel), and the like. The data means data transmitted via the data channel. The data channel may be read as a shared channel.

Here, the control signal and reference signal processing unit 240 may receive downlink control information (DCI). The DCI includes fields for storing DCI Formats, Carrier indicator (CI), BWP indicator, FDRA (Frequency Domain Resource Assignment), TDRA (Time Domain Resource Assignment), MCS (Modulation and Coding Scheme), HPN (HARQ Process Number), NDI (New Data Indicator), RV (Redundancy Version), and the like as existing fields.

The value stored in the DCI Format field is an information element for specifying the format of the DCI. The value stored in the CI field is an information element for specifying the CC to which the DCI is applied. The value stored in the BWP indicator field is an information element that specifies the BWP to which the DCI applies. The BWP that can be specified by the BWP indicator is set by the information element (BandwidthPart-Config) included in the RRC message. The value stored in the FDRA field is an information element that specifies the frequency domain resource to which the DCI applies. The frequency domain resource is specified by the value stored in the FDRA field and the information element (RA Type) included in the RRC message. The value stored in the TDRA field is an information element that specifies the time domain resource to which the DCI applies. The time domain resource is specified by the value stored in the TDRA field and the information element (pdsch-TimeDomainAllocationList, pusch-TimeDomainAllocationList) included in the RRC message. The time domain resource may be specified by the value stored in the TDRA field and the default table. The value stored in the MCS field is an information element that specifies the MCS to which the DCI applies. The MCS is specified by the value stored in the MCS and the MCS table. The MCS table may be specified by the RRC message or by RNTI scrambling. The value stored in the HPN field is an information element that specifies the HARQ process to which the DCI is applied. The value stored in the NDI field is an information element that specifies whether or not the data to which the DCI is applied is the initial transmission data. The value stored in the RV field is an information element that specifies the redundancy of the data to which the DCI is applied.

In the embodiment, the control signal and reference signal processing unit 240 constitutes a reception unit that receives two or more downlink reference signals at different timings on the time axis via the NTN. The downlink reference signal may be referred to as a DL-PRS (Downlink Positioning Reference Signal). The control signal and reference signal processing unit 240 may transmit two or more uplink reference signals at different timings on the time axis via the NTN. The uplink reference signal may be referred to as a UL-SRS (Sounding Reference Signal).

The encoding/decoding unit 250 executes data division/concatenation, channel coding/decoding, and the like for each predetermined communication destination (gNB100 or another gNB).

Specifically, the encoding/decoding unit 250 divides the data output from the data transmission and reception unit 260 into predetermined sizes, and executes channel coding on the divided data. the encoding/decoding unit 250 decodes the data output from the modulation and demodulation unit 230 and concatenates the decoded data.

The data transmission and reception unit 260 transmits and receives protocol data units (PDU) and service data units (SDU). Specifically, the data transmission and reception unit 260 assembles and disassembles PDUs/SDUs in a plurality of layers (Media access control layer (MAC), radio link control layer (RLC), and packet data convergence protocol layer (PDCP)). The data transmission and reception unit 260 also executes data error correction and retransmission control based on HARQ (Hybrid Automatic Repeat Request).

The control unit 270 controls each functional block constituting the UE200. In the embodiment, the control unit 270 constitutes a control unit that controls a reporting of measurement results related to each of two or more DL-PRSs in a specific control (hereinafter, the first specific control) for estimating the position information of the UE200 based on two or more DL-PRSs. The measurement result may be reported to the LMF300 via the satellite 150 and the gNB100. The first specific control may be OTDOA (Observed Time Difference Of Arrival) Positioning using DL-PRS, or may be a part of Multi-RTT (Round Trip Time) Positioning.

The control unit 270 may assume a specific control (Hereinafter, the second specific control) for estimating the position information of the UE200 based on two or more UL-SRSs. The second specific control may be OTDOA Positioning using UL-SRS, or may be a part of Multi-RTT Positioning.

Second, the functional block configuration of the gNB100 will be described.

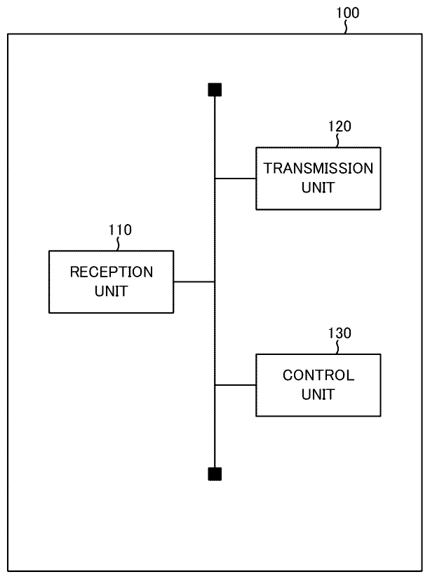

FIG. 5 is a functional block configuration diagram of the gNB100. As shown in FIG. 5, the gNB100 includes a reception unit 110, a transmission unit 120, and a control unit 130.

The reception unit 110 receives various signals from the UE200. The reception unit 110 may receive the UL signal via PUCCH or PUSCH. In an embodiment, the reception unit 110 constitutes a reception unit that receives 2 or more UL-SRS at different timings on the time axis via NTN.

The transmission unit 120 transmits various signals to the UE200. transmission unit 120 may transmit the DL signal via PDCCH or PDSCH. transmission unit 120 may transmit 2 or more DL-PRS at different timings on the time axis via NTN.

The control unit 130 controls the gNB100. In the embodiment, the control unit 130 constitutes a control unit that controls a reporting of the measurement results related to each of the two or more UL-SRS in the specific control (hereinafter, second specific control) for estimating the position information of the UE200 based on the two or more UL-SRS. The control unit 130 may assume the specific control (first specific control) for estimating the position information of the UE200 based on the two or more DL-PRS.

Third, the functional block configuration of the LMF300 will be described.

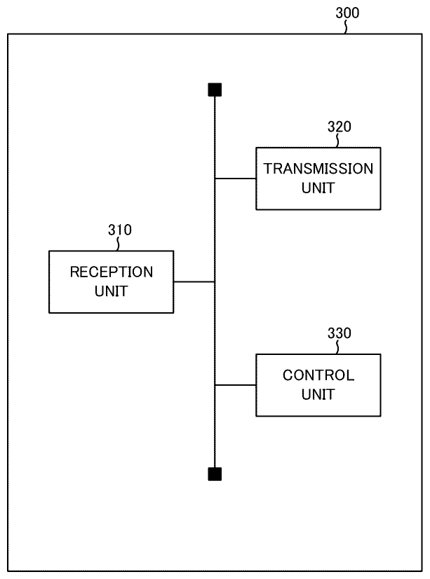

FIG. 6 is a functional block configuration diagram of the LMF300. As shown in FIG. 6, the LMF300 includes a reception unit 310, a transmission unit 320, and a control unit 330.

The reception unit 310 may receive a message such as a measurement result related to the first specific control from the UE200. The message may be referred to as LPP Provide Location Information. The reception unit 310 may receive a message, such as a measurement result related to the second specific control, from the gNB100. The message may be referred to as an NRPPa (NR Positioning Protocol A) message (Type: Measurement Report). The reception unit 310 may receive a message used for measurement related to the second specific control from the gNB100. The message may be referred to as an NRPPa message (Type: POSITIONING INFORMATION REQUEST).

The transmission unit 320 may transmit a message used for measurement related to the first specific control to the UE200. The message may be referred to as an LPP Provide Assistance Data. The transmission unit 320 may transmit a message requesting measurement related to the second specific control to the gNB100. The message may be referred to as an NRPPa message (Type: Measurement Request).

The control unit 330 controls the LMF300. control unit 330 may assume specific control (first specific control) for estimating the position information of the UE200 based on two or more DL-PRSs. The control unit 330 may assume specific control (second specific control) for estimating the position information of the UE200 based on two or more UL-SRS.

### (3) Problems

Next, the problems of the embodiment will be described. As described above, in NTN, DL-PRS and/or UL-SRS are relayed by the satellite 150. However, as a result of careful study, the inventors have found that it is assumed that it is difficult to capture a plurality of satellites 150 in the methods such as Multi-RTT, DL-TDOA, and UL-TDOA.

Here, the inventors have noticed that the operating position (ephemeris) of the satellite 150 can change from time to time. In the embodiment, a specific control for estimating the position information of the UE200 based on two or more DL-PRS and/or UL-SRS communicated from a single satellite 150 at different timings on a time axis via NTN is newly defined based on this attention.

### (4) Specific Control

Next, the specific control of the embodiment will be described. Here, as a specific control, a first specific control for estimating the position information of the UE200 based on two or more DL-PRS/or UL-SRS will be exemplified.

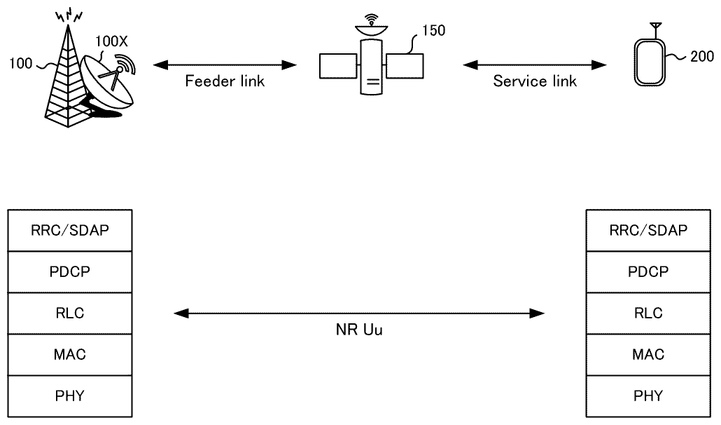

First, a protocol will be described. As shown in FIG. 7, the gNB100 has a protocol stack such as PHY, MAC, RLC, PDCP, RRC/SDAP, and the like. Similarly, the UE200 has a protocol stack such as PHY, MAC, RLC, PDCP, RRC/SDAP, and the like. The satellite 150 relays communications between the gNB100 and the UE200.

Here, the link between the gNB100 (NTN gateway 100X) and the satellite 150 may be called a feeder link. The link between the satellite 150 and the UE200 may be called a service link. The interface between the gNB100 and the UE200 may be called NR Uu.

The network architecture of the NTN may be assumed to be FDD or TDD. The cells on the ground may be fixed or movable. The UE200 may be capable of supporting GNSS (Global Navigation Satellite System). As the UE200, a handheld device of power class 3 may be assumed for FR1, and VSAT (Very small aperture terminal) may be assumed for at least FR2.

The network architecture of the NTN may assume a regenerative payload. For example, the function of the gNB100 may be mounted on a satellite or a flight vehicle. The gNB-DU (Distributed Unit) may be mounted on a satellite or a flight vehicle, and the gNB-CU (Central Unit) may be arranged as a ground station.

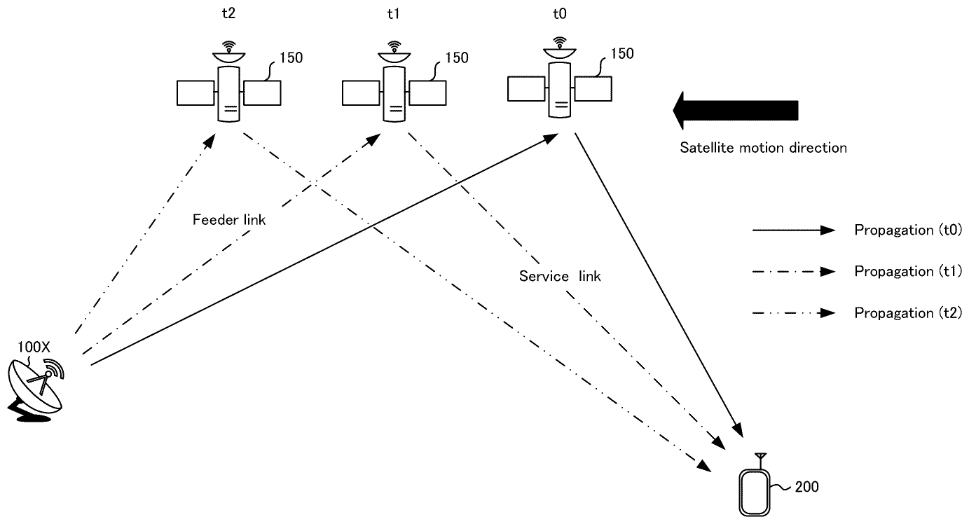

Second, the first specific control will be described. As shown in FIG. 8, it is assumed that the satellite 150 moves on a satellite orbit or the like. That is, it is assumed that the position of the satellite 150 at time t0, the position of the satellite 150 at time t1, and the position of the satellite 150 at time t2 are different.

Here, in the first specific control, the UE200 controls the reporting of measurement results for each of two or more DL-PRSs. The measurement results may include NTN-RSTD (Reference Signal Time Difference). The NTN-RSTD is a difference between the time at which the UE200 receives a basis reference signal (Hereinafter, basis PRS) and the time at which the UE200 receives the target reference signal (Below are the applicable PRS). For example, the DL-PRS (t0) transmitted at time t0 is the basis PRS, and the DL-PRS (t1) transmitted at time t1 and the DL-PRS (t2) transmitted at time t2 are the target PRS. Note that t0, t1, and t2 may each be the transmission time of the DL-PRS at gNB100, the transmission time of the DL-PRS at satellite 150, the reception time of the DL-PRS at UE200, or the time determined based on these.

The UE200 can measure the NTN-RSTD(t1, t0) at the time corresponding to time t1 as the NTN-RSTD (Reference Signal Time Difference). The NTN-RSTD(t1, t0) may be represented by (Service link propagation delay (t1)+Feeder link propagation delay (t1))−(Service link propagation delay (t0)+Feeder link propagation delay (t0)). Similarly, the UE200 can measure the NTN-RSTD(t2, t0) at the time corresponding to time t2 as the NTN-RSTD. The NTN-RSTD(t2, t0) may be represented by (Service link propagation delay (t2)+Feeder link propagation delay (t2))−(Service link propagation delay (t0)+Feeder link propagation delay (t0)). The UE200 may report Service link propagation delay and Feeder link propagation delay to gNB100 or LMF300, respectively, and may report the sum of Service link propagation delay and Feeder link propagation delay to gNB100 or LMF300. The NTN-RSTD may also be reported to gNB100 or LMF300.

Note that the Service link propagation delay (tx) is the Service link propagation delay corresponding to time tx. The Feeder link propagation delay (ty) is the Feeder link propagation delay corresponding to time ty. The Feeder link propagation delay (t) may be referred to as the Reference propagation delay (t0).

Although not particularly limited, the Feeder link propagation delay (ty) may be reported by the gNB100. For example, the Feeder link propagation delay (ty) may be identified using one way-propagation delay through NRPPa messages reporting the delay between the gNB100 and the satellite 150, distance reporting, sum of K_mac, common TA (N_{TA, common}), etc. K_mac may be a parameter for determining when to apply the configuration received by the MAC-CE. Alternatively, the gNB100 may report the geographic location of the NTN gateway 100X to the LMF300. The LMF300 may identify the Feeder link propagation delay (ty) based on the distance between the NTN gateway 100X and the satellite 150. The position of the satellite 150 may be reported from the gNB100 to the LMF300. The position of the satellite 150 may be specified based on the position/orbit information of the satellite 150 reported from the gNB100 to the LMF300.

Although the first specific control for estimating the position information of the UE200 based on two or more DL-PRSs has been exemplified here, the second specific control for estimating the position information of the UE200 based on two or more UL-SRSs is the same. That is, the specific control described above can be applied to OTDOA Positioning using DL-PRS, OTDOA Positioning using UL-SRS, and Multi-RTT Positioning.

### (5) Operation Example

Next, an operation example of the embodiment will be described. The operation example will be divided into OTDOA Positioning using DL-PRS, OTDOA Positioning using UL-SRS, and Multi-RTT Positioning.

### (5.1) OTDOA Positioning Using DL-PRS

As OTDOA Positioning using DL-PRS, the following operation example can be considered.

### (5.1.1) Operation Example 1

As described above, the UE200 measures NTN-RSTD for the DL-PRS (target PRS). For example, taking the case shown in FIG. 8 as an example, the UE200 measures NTN-RSTD(t1, t0) at time t1 and measures NTN-RSTD(t2, t0) at time t2.

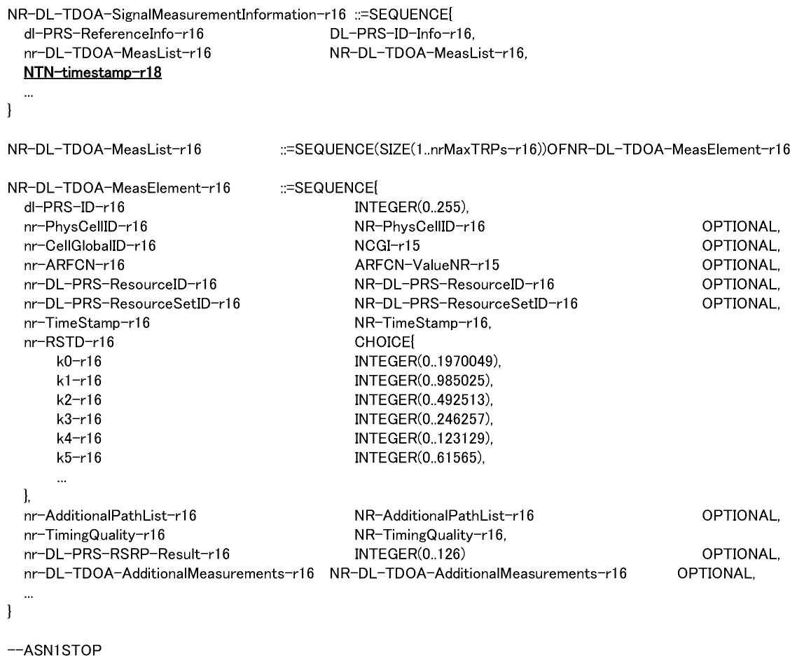

In Operation Example 1, the measurement result includes time information for a basis PRS which is one of two or more DL-PRS. As shown in FIG. 9, the time information is a newly defined information element and may be referred to as NTN-timestamp-r18. NTN-timestamp-r18 may be information indicating a time when the UE200 receives the basis PRS. NTN-RSTD may be the difference between NTN-timestamp-r18 and nr-TimeStamp-r16. The format of NTN-timestamp-r18 may be the same as that of the existing nr-TimeStamp-r16.

For example, in the case shown in FIG. 8, the UE200 includes the time information about the basis PRS (t0) in the measurement result including NTN-RSTD(t1, t0). Similarly, the UE200 includes the time information about the basis PRS (t0) in the measurement result including NTN-RSTD(t2, t0).

### (5.1.2) Operation Example 2

In Operation Example 2, the UE200 omits the specific information element which is at least a part of the information element used in the estimation of the position information of the UE200 using TN, and executes the first specific control. The specific information may include one or more information elements selected from among the TRP IDs of TRPs provided by PCI (Physical Cell ID), GCI (Global Cell ID), and gNB100. The specific information element may include other information elements. The details of the specific information elements will be described below.

First, the assistance data transmitted from the gNB100 to the LMF300 will be described. In the embodiment, it is assumed that there is only one gNB100 and one satellite 150, so the following information elements can be considered as the specific information elements that can be omitted in the assistance data.

The specific information elements that can be omitted in the assistance data may include PCI, GCI, and TRP IDs. The PCI, GCI, and TRP IDs are information elements used in the case where 2 or more cells can be assumed (Namely, estimation of the position information of the UE200 using TN).

The specific information elements that can be omitted in the assistance data may include SSB information of TRPs (the time/frequency occupancy of SSBs). The SSB information of TRPs is information elements used in the case where non-serving gNB can be used (Namely, estimation of the position information of the UE200 using TN).

The optional specific information elements in the assistance data may include timing information of TRPs provided by the gNB100. The timing information of TRPs is an information element used in a case where a non-serving gNB can be used (Namely, estimation of the position information of the UE200 using TN).

Second, the assistance data transmitted from the LMF300 to the UE200 will be described. In the embodiment, it is assumed that there is only one gNB100 and one satellite 150, so the following information elements are considered as the optional specific information elements in the assistance data.

The optional specific information elements in the assistance data may include PCI, GCI, and TRP IDs of candidate TRPs for measurement. The PCI, GCI, and TRP IDs of candidate TRPs for measurement are information elements used in the case where 2 or more cells can be assumed (Namely, estimation of the position information of the UE200 using TN).

The optional specific information element in the assistance data may include SSB information of TRPs (the time/frequency occupancy of SSBs). The SSB information of TRPs is an information element used in the case where DL-PRS can be transmitted from 2 or more TRPs (Namely, estimation of the position information of the UE200 using TN).

The optional specific information element in the assistance data may include the relative timing of the candidate TRPs with respect to the serving (reference) TRP. The relative timing is an information element used in the case where DL-PRS can be transmitted from 2 or more TRPs (Namely, estimation of the position information of the UE200 using TN).

Third, the measurement result reported from the UE200 to the LMF300 will be described. In the embodiment, it is assumed that there is 1 gNB100 and 1 satellite 150, so the following information elements are considered as optional specific information elements in the measurement result.

Optional specific information elements in the measurement result may include PCI, GCI, and TRP ID. The PCI, GCI, and TRP IDs are information elements used in a case where 2 or more cells can be assumed (Namely, estimation of the position information of the UE200 using TN).

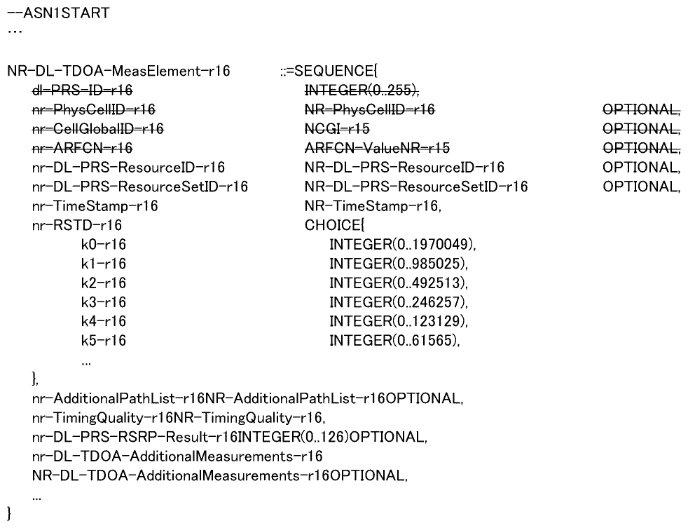

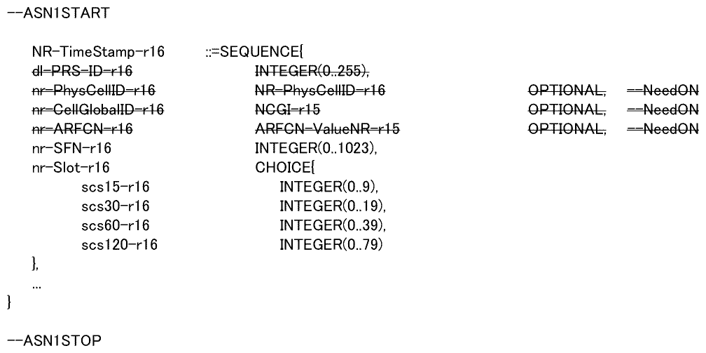

For example, in the case where the UE200 reports measurement results, as shown in FIG. 10, dl-PRS-ID-r16, nr-PhysCellID-r16, nr-CellGlobalID-r16, and nr-ARFCN-r16 may be omitted. In the case where the UE200 reports NR-timestamp-r16, as shown in FIG. 11, dl-PRS-ID-r16, nr-PhysCellID-r16, nr-CellGlobalID-r16, and nr-ARFCN-r16 may be omitted.

### (5.1.3) Operation Example 3

In operation example 3-1, the gNB100 reports the position/orbit information (satellite ephemeris) of the satellite 150 at each time to the LMF300 before measurement. The satellite ephemeris may be reported by an NRPPa message. The LMF300 can determine the position of the satellite 150 at each time based on the satellite ephemeris. Under such a premise, the time for determining the position of the satellite 150 based on the satellite ephemeris may be determined by the LMF300 with the following options.

In Option 3-1, gNB100 may report the time it sent the DL-PRS from gNB100 to LMF300. In Alt. 1, the time it sent the DL-PRS from gNB100 may be explicitly reported. The time may be reported by timestamp. The time may be reported as a time corresponding to each of two or more DL-PRS. The message reporting the time may be a newly defined NRPPa message. In Alt. 2, the time at which the DL-PRS was sent from gNB100 may be implicitly reported by reporting the DL-PRS resource settings. gNB100 may report the resource settings of two or more DL-PRS associated with each of two or more timestamps once, or may report the resource settings of one or more DL-PRS associated with each of one or more timestamps multiple times.

In Option 3-2, gNB100 may report the time at which the DL-PRS was sent from satellite 150 to LMF300. In Alt. 1, the time at which the DL-PRS was transmitted from the satellite 150 may be explicitly reported. The time may be reported by timestamp. The time may be reported as a time corresponding to each of two or more DL-PRS. The message reporting the time may be a newly defined NRPPa message. The gNB100 may report two or more timestamps once, or may report one or more timestamps multiple times.

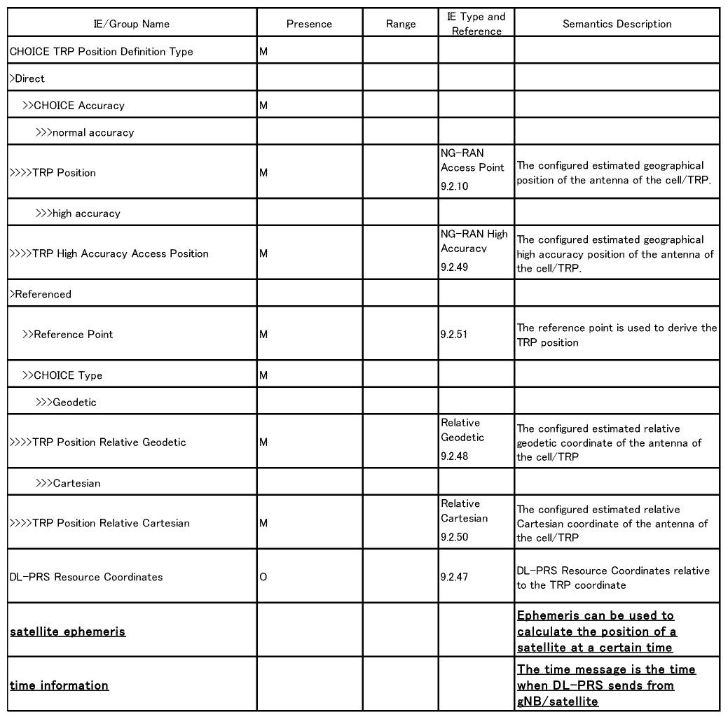

For example, as shown in FIG. 12, in the NRPPa message, satellite ephemeris may be newly defined, and time information may be newly defined. The satellite ephemeris and time information are newly defined information for an existing NRPPa message (3GPP TS38.455).

In operation example 3-2, the gNB100 may report the geographic location information of the satellite 150 at different times to the LMF300. A message for reporting geographic location information of the TRP may be used as a message for reporting geographic location information. The message for reporting geographic location information may be a newly defined NRPPa message. The geographic location information may be represented by {X, Y, Z} [m]
and velocity {VX, VY, VZ} [m/s]
in an ECEF coordinate system (Earth-Centered, Earth-Fixed coordinate system). The gNB100 may report 2 or more geographic location information at one time, or may report 1 or more geographic location information at multiple times.

### (5.1.4) Operation Example 4

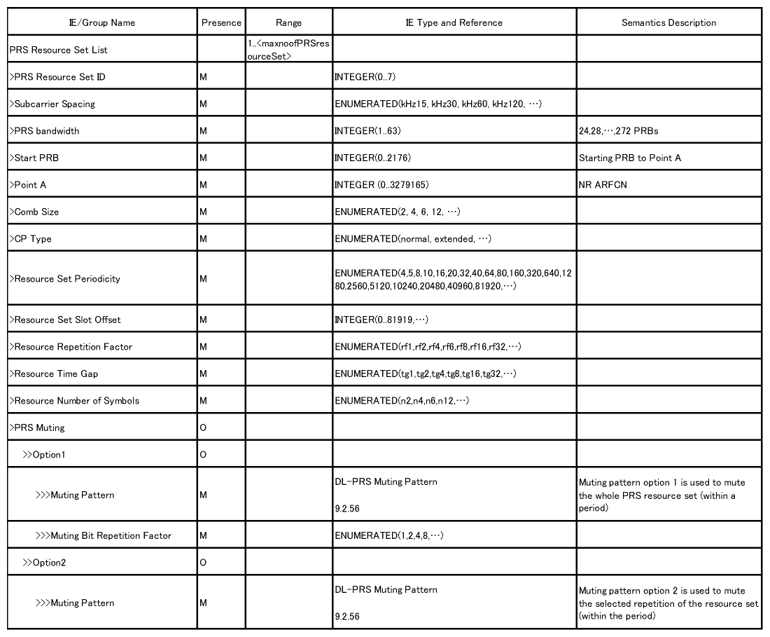

In Operation Example 4-1, the gNB100 instructs the UE200 to set the DL-PRS resource settings, and reports the DL-PRS resource settings to the LMF300 through an NRPPa message. The gNB100 may instruct the UE200 to set the DL-PRS resource settings through an RRC signaling. The contents of the RRC signaling may be the same as the contents of the DL-PRS settings reported to the LMF300 through an NRPPa message (see FIG. 13). Here, the following options can be considered as a method of instructing the UE200 to set the DL-PRS resource settings.

In Option 4-1-1, the DL-PRS resource may be set to Periodic. The gNB100 instructs the UE200 to set the DL-PRS resource via RRC signaling.

In Option 4-1-2, the DL-PRS resource may be set to Semi-Persistent. The gNB100 instructs the UE200 to set the DL-PRS resource via RRC signaling, and the DL-PRS resource setting is activated/deactivated by the MAC CE. For example, the DL-PRS resource setting may be activated before the estimation of the location information of the UE200 and deactivated after the estimation of the location information of the UE200. The DL-PRS resource setting may be activated/deactivated for each DL-PRS measurement.

In option 4-1-3, the DL-PRS resource may be set to Aperiodic. The gNB100 instructs the UE200 to set the DL-PRS resource settings by RRC signaling or MAC CE, and the DL-PRS resource settings are enabled/disabled by DCI.

The DL-PRS resource settings may be indicated/reported to the UE100 and the LMF300 at the same time, or may be indicated/reported at different times.

In operation example 4-2, the gNB100 may report the DL-PRS resource settings to the LMF300 by NRPPa messages, and the LMF300 may instruct the UE200 to set the DL-PRS resource settings by LPP messages.

In option 4-2-1, the DL-PRS resource may be set to Periodic. The LMF300 instructs the UE200 to set the DL-PRS resource settings by LLP messages.

In option 4-2-2, the DL-PRS resource may be set to Semi-Persistent. The LMF300 instructs the UE200 to set the DL-PRS resource by an LLP message. The gNB100 sends the PRS resource set ID to be activated/deactivated, the correspondence between the PRS resource set ID and the activation time to the UE200.

In option 4-2-3, the DL-PRS resource may be set to Aperiodic. The LMF300 instructs the UE200 to set the DL-PRS resource by an LLP message. The gNB100 sends the DL-PRS setting information, the DL-PRS trigger list, and the activation time to the UE200.

### (5.1.5) Operation Example 5

In operation example 5-1, the LMF300 may instruct the gNB100 to set the DL-PRS resource set ID, the DL-PRS resource ID, and the timestamp. The timestamp may be the time at which the UE200 receives the DL-PRS corresponding to the DL-PRS resource ID. Alternatively, the LMF300 may request the geographic location information of the satellite 150 at the time specified by the timestamp from the gNB100. In such a case, the gNB100 may perform the following operations.

In Option 5-1-1, the gNB100 may report the geographic location information and timestamp of the satellite 150 for all DL-PRS resource set IDs and DL-PRS resource IDs for the timestamp indicated/requested by the LMF300.

In Option 5-1-2, the gNB100 may omit reporting the geographic location information when the geographic coordinates of the satellite 150 for the two DL-PRS resources are closer than a threshold, or when the interval between the two timestamps is shorter than a threshold, and may report that new geographic location information of the satellite 150 is required. The need for new geographic location information of the satellite 150 may be reported by a 1 bit value. The LMF300 may use the last reported geographic location information from the gNB100.

The LMF300 may execute an instruction such as a DL-PRS resource set ID and a request for geographic location information at the same timing, or may execute an instruction such as a DL-PRS resource set ID and a request for geographic location information at different timings.

In operation 5-2, the LMF300 may dynamically/actively request the geographic location information of the satellite 150 for the DL-PRS resource set ID, DL-PRS resource ID to the gNB100. In such a case, the gNB100 may perform the following operations.

In option 5-2-1, the gNB100 may report the geographic location information and timestamp of the satellite 150 for all the DL-PRS resource set IDs, DL-PRS resource IDs indicated/requested by the LMF300.

In option 5-2-2, the gNB100 may omit reporting the geographic location information if the geographic coordinates of the satellite 150 for the two DL-PRS resources are closer than a threshold, or if the interval between the two timestamps is less than a threshold, and may report that new geographic location information of the satellite 150 is required. The need for new geographic location information of the satellite 150 may be reported by a 1 bit value. The LMF300 may use the last reported geographic location information from the gNB100.

The geographic position information of the satellite 150 related to the DL-PRS resource set ID and the DL-PRS resource ID may be information indicating the geographic coordinates of the satellite 150 at the time when the DL-PRS corresponding to the DL-PRS resource set ID and the DL-PRS resource ID is transmitted by the gNB100, relayed by the satellite 150, or received by the UE200.

When the gNB100 reports the geographic position information of the satellite 150, the gNB100 may report the DL-PRS resource set ID, the DL-PRS resource ID, and the timestamp corresponding to the geographic position information together with the geographic position information.

The reporting method of the geographic position information may be the same as that of Operation Example 3.

(5.2) OTDOA Positioning using UL-SRS

The following operation examples are considered as OTDOA Positioning using UL-SRS.

### (5.2.1) Operation Example 6

The gNB100 measures the Uplink Relative Time of Arrival (UL-RTOA) for the UL-SRS. As in operation example 1, the reception time difference of the UL-SRS received by the gNB100 via the single satellite 150 is measured. The gNB100 reports the measurement result to the LMF300.

In operation example 6, the measurement result may include time information for a basis reference signal (basis SRS) which is one of two or more UL-SRS. The time information is a newly defined information element and may be information contained in an NRPPa message.

### (5.2.2) Operation Example 7

In operation example 7, the gNB100 performs second specific control by omitting a specific information element which is at least a part of the information element used in estimating the position information of the UE200 using TN. The specific information may include 1 or more information elements selected from TRP IDs of TRPs provided by the PCI, GCI, and gNB100. The specific information element may include other information elements. Details of the specific information element will be described below.

First, the assistance data transmitted from the gNB100 to the LMF300 will be described. In the embodiment, it is assumed that there is one gNB100 and one satellite 150, so the following information elements are considered as the specific information elements that can be omitted in the assistance data.

The specific information elements that can be omitted in the assistance data may include PCI, GCI, and TRP IDs. The PCI, GCI, and TRP IDs are information elements that are used in the case where 2 or more cells can be assumed (Namely, estimation of the position information of the UE200 using TN).

Second, the measurement results reported from the gNB100 to the LMF300 will be described. In the embodiment, it is assumed that there is only one gNB100 and one satellite 150, and therefore, the following information elements are considered as optional specific information elements in the measurement result.

The optional specific information elements in the measurement result may include PCI, GCI, and TRP IDs. The PCI, GCI, and TRP IDs are information elements used in the case where 2 or more cells can be assumed (Namely, estimation of the position information of the UE200 using TN).

Third, the measurement request information transmitted from the LMF300 to the gNB100 will be described. In the embodiment, the case where the gNB100 and the satellite 150 are 1 is assumed, and the following information elements are considered as optional specific information elements in the measurement request information.

The optional specific information elements in the measurement request information may include the TRP ID of the TRP receiving the UL-SRS. The TRP ID is an information element used in the case where 2 or more TRPs can be assumed (Namely, estimation of the position information of the UE200 using TN).

The optional specific information element in the measurement request information may include a UE-SRS configuration. The UE-SRS configuration is an information element used in the case where 2 or more UE-SRS configurations can be assumed (Namely, estimation of the position information of the UE200 using TN).

The optional specific information element in the measurement request information may include UL timing information together with timing uncertainty regarding the reception of the SRS by candidate TRPs. The UL timing information together with timing uncertainty is an information element used in the case where 2 or more candidate TRPs can be assumed (Namely, estimation of the position information of the UE200 using TN).

Fourth, the UL-SRS transmission characteristics information transmitted from the LMF300 to the gNB100 will be described. In the embodiment, it is assumed that there is only one gNB100 and one satellite 150, so the following information elements are considered as optional specific information elements in the UL-SRS transmission characteristics information.

The optional specific information elements in the UL-SRS transmission characteristics information may include PCI, SSB Index, and SSB configuration (the time/frequency occupancy of SSBs) contained in the Pathloss reference. PCI, SSB Index, and SSB configuration are information elements used in cases where a non-serving gNB may be used (Namely, estimation of the position information of the UE200 using TN).

The optional specific information elements in the UL-SRS transmission characteristics information may include PCI, SSB Index, and SSB configuration (the time/frequency occupancy of SSBs) contained in the Spatial relation info. PCI, SSB Index, and SSB configuration are information elements used in cases where a non-serving gNB may be used (Namely, estimation of the position information of the UE200 using TN).

### (5.2.3) Operation Example 8

In Operation Example 8-1, the gNB100 reports the satellite ephemeris of the satellite 150 at each time to the LMF300 prior to measurement. The satellite ephemeris may be reported by an NRPPa message. The LMF300 can determine the position of the satellite 150 at each time based on the satellite ephemeris. Under these assumptions, the time for locating the satellite 150 based on the satellite ephemeris may be captured by the LMF300 with the following options:

In Option 8-1, the gNB100 may report the time at which the UL-SRS was transmitted from the UE200 to the LMF300. In Alt. 1, the time at which the UL-SRS was transmitted from the gNB 100 may be explicitly reported. The time may be reported by timestamp. The time may be reported as a time corresponding to each of two or more UL-SRSs. The message reporting the time may be a newly defined NRPPa message. In Alt. 2, the time at which the UL-SRS was sent from gNB100 may be implicitly reported by reporting the UL-SRS resource settings. gNB100 may report the resource settings of two or more UL-SRSs associated with each of two or more timestamps once, and may report the resource settings of one or more UL-SRSs associated with each of one or more timestamps multiple times.

In option 8-2, gNB100 may report the time of transmission of the UL-SRS from satellite 150 to LMF300. In Alt. 1, the time of transmission of the UL-SRS from satellite 150 may be explicitly reported. The time may be reported by timestamp. The time may be reported as a time corresponding to each of two or more UL-SRS. The message reporting the time may be a newly defined NRPPa message. The gNB100 may report two or more timestamps once, and may report one or more timestamps multiple times.

In operation example 8-2, the gNB100 may report the geographic location information of the satellite 150 at different times to the LMF300. The message reporting the geographic location information of the TRP may be used as the message reporting the geographic location information. The message reporting the geographic location information may be a newly defined NRPPa message. Geographic location information may be expressed as {X, Y, Z} [m]
and velocity {VX, VY, VZ} [m/s]
in an ECEF coordinate system (Earth-Centered, Earth-Fixed coordinate system). The gNB100 may report two or more geographic locations at one time, and may report one or more geographic locations multiple times.

### (5.2.4) Operation Example 9

In Operation Example 9-1, the LMF300 may indicate the UL-SRS resource set ID, UL-SRS resource ID, and timestamp to the gNB100. The timestamp may be the time at which the gNB100 receives the UL-SRS corresponding to the UL-SRS resource ID. On the other hand, the LMF300 may request the geographic location of the satellite 150 from the gNB100 at the time specified by the timestamp. In such a case, the gNB 100 may perform the following operations.

In option 9-1-1, the gNB100 may report the geographic location and timestamp of the satellite 150 for all UL-SRS resource set IDs, UL-SRS resource IDs for the timestamp indicated/requested by the LMF300.

In Option 9-1-2, the gNB 100 may omit reporting the geographic location information if the geographic coordinates of the satellites 150 with respect to the two UL-SRS resources are closer than a threshold, or if the interval between the two timestamps is shorter than a threshold, and may report that new geographic location information of the satellites 150 is required. The need for new geographic location information of the satellites 150 may be reported by a bit value. The LMF300 may use the last reported geographic location information from the gNB100.

The LMF300 may execute an instruction such as a UL-SRS resource set ID and geographic location information at the same timing, or may execute an instruction such as a UL-SRS resource set ID and geographic location information at different timings.

In operation example 9-2, the LMF300 may dynamically/actively request the gNB100 for geographic location information of the satellites 150 regarding the UL-SRS resource set ID and the UL-SRS resource ID. In such a case, the gNB100 may perform the following operation.

In Option 9-2-1, gNB100 may report satellite 150 geographic location information and timestamps for all UL-SRS resource set IDs, UL-SRS resource IDs indicated/requested by LMF300.

In Option 9-2-2, gNB100 may omit reporting geographic location information if the geographic coordinates of satellite 150 for the two UL-SRS resources are closer than a threshold, or if the interval between the two timestamps is less than a threshold, and may report that new geographic location information for satellite 150 is required. The need for new geographic location information for satellite 150 may be reported by a 1 bit value. LMF300 may use the last reported geographic location information from gNB100.

The geographic location information for satellite 150 for UL-SRS resource set ID and UL-SRS resource ID may be information indicating the geographic coordinates of satellite 150 at the time transmitted by UE200, relayed by satellite 150, or received by gNB100 for the UL-SRS corresponding to UL-SRS resource set ID and UL-SRS resource ID.

When gNB100 reports the geographic location information for satellite 150, gNB100 may report the geographic location information and corresponding UL-SRS resource set ID, UL-SRS resource ID, and timestamp.

The method of reporting the geographic location information may be the same as that of operation example 8.

### (5.3) Multi-RTT Positioning

Multi-RTT Positioning may be a combination of OTDOA Positioning using DL-PRS and OTDOA Positioning using UL-SRS. Therefore, the following operation examples can be considered as Multi-RTT Positioning. Further, the UE200 may report the time difference between the DL-PRS reception time and the UL-SRS transmission time to the gNB100 and/or the LMF300. The gNB100 may report the time difference between the DL-PRS transmission time and the UL-SRS reception time to the LBF300. These time differences may be reported for each DL-PRS transmitted and received via the same satellite 150.

### (5.3.1) Operation Example 10

In operation example 10, at least one of operation examples 1 and 6 described above may be employed.

### (5.3.2) Operation Example 11

In operation example 11, at least one of operation examples 2 and 7 described above may be employed.

### (5.3.3) Operation Example 12

In operation example 12, at least one of operation examples 3 and 8 described above may be employed.

### (5.3.4) Operation Example 13

In operation example 13, operation example 4 described above may be employed.

### (5.3.5) Operation Example 14

In Operation Example 14, at least one of Operation Example 5 and Operation Example 9 described above may be employed.

### (6) Operational Effects

In the embodiment, a first specific control for estimating the position information of the UE200 is defined based on two or more DL-PRSs received at different timings on the time axis via the NTN. Alternatively, a second specific control for estimating the position information of the UE200 is defined based on two or more UL-SRS received at different timings on the time axis via the NTN. According to such a configuration, when it is assumed that it is difficult to acquire a plurality of satellites 150, the position information of the UE200 can be estimated using one satellite 150.

In the embodiment, by introducing the first specific control and the second specific control, time information related to a basis reference signal (basis PRS or basis SRS) may be reported (Operation Examples 1, 6, and 10). According to this configuration, the position information of the UE200 can be appropriately estimated using one satellite 150.

In the first specific control and the second specific control, the specific information element which is at least a part of the information element used in estimating the position information of the UE200 using TN may be omitted (Operation Examples 2, 7, and 11). According to this configuration, the signaling load can be reduced.

In the embodiment, the gNB100 may report the time when the DL- PRS is transmitted from the gNB100 to the LMF300, and may report the time when the DL-PRS is transmitted from the satellite 150 to the LMF300 (Operation Example 3-1, 12). The gNB100 may report the time when the UL-SRS is transmitted from the UE200 to the LMF300, and may report the time when the DL-PRS is transmitted from the satellite 150 to the LMF300 (Operation Example 8-1, 12). According to this configuration, the signaling load can be reduced, and the complexity of the LMF300 can be suppressed, as compared with the case where the position information of the UE200 is estimated using 2 or more satellites 150.

In the embodiment, the gNB100 may report the geographic position information of the satellite 150 at different times to the LMF300 (Operation Example 3-2, 12). According to such a configuration, affinity with the operation of estimating the position information of the UE200 using TN is high.

In the embodiment, the gNB100 instructs the UE200 to set the DL-PRS resource setting and reports the DL-PRS resource setting to the LMF300 through the NRPPa message (Operation Example 4-1, 13). According to such a configuration, since the DL-PRS resource setting is directly specified from the gNB100, the signaling load can be reduced and the complexity of the UE200 can be suppressed. In addition, delay related to the DL-PRS resource setting can be suppressed.

In the embodiment, the gNB100 may report the DL-PRS resource setting to the LMF300 through the NRPPa message, and the LMF300 may instruct the UE200 to set the DL-PRS resource setting through the LPP message (Operation Example 4-2, 13). According to such a configuration, affinity with the operation of estimating the location information of the UE200 using TN is high.

In the embodiment, the gNB100 may report to the LMF300 the geographic location information of the satellite 150 related to the DL-PRS resource set ID, the DL-PRS resource ID, etc. instructed/requested by the LMF300. According to such a configuration, the estimation accuracy of the position information of the UE200 is improved.

### (7) Other Embodiments

Although the contents of the present invention have been described above according to the embodiments, it will be obvious to those skilled in the art that the present invention is not limited to these descriptions and that various modifications and improvements are possible.

The foregoing disclosure exemplifies the case where the single non-terrestrial network device that relays the UL or DL signal in the NTN is the satellite 150. However, the foregoing disclosure is not limited to this. The single non-terrestrial network device may be a node that constitutes the NTN in the air, may be referred to as an airborne node, may be referred to as an airborne vehicle, or may be referred to as an airborne vehicle.

Although not specifically addressed in the foregoing disclosure, measurements regarding the position of the UE200 may include measurements of the RSRP of the DL-PRS. Measurement of the position of the UE200 may include measurement of the RSRP of the UL-SRS.

Although not specifically addressed in the above disclosure, omission of a specific information element may be considered to include omission of transmission of a specific information element, omission of receipt of a specific information element, disregard of a specific information element, exclusion of a specific information element, and the like.

Although not specifically addressed in the above disclosure, the following UE Capabilities may be defined: The following UE Capabilities may be reported from the UE200 to the gNB 100:

The UE Capability may include an information element indicating whether any one or more of the operation examples selected from the operation examples 1 to 14 described above are supported. The UE Capability may include an information element indicating whether any one or more of the options selected from the options described above are supported.

In the foregoing disclosure, configure, activate, update, indicate, enable, specify, and select may be read interchangeably. Similarly, link, associate, correspond, and map may be read interchangeably, and allocate, assign, monitor, and map may be read interchangeably.

Furthermore, specific, dedicated, UE-specific, and UE-specific may be read interchangeably. Similarly, common, shared, group-common, UE-common, and UE-shared may be read interchangeably.

The block configuration diagram (FIGS. 4-6) used in the description of the above-described embodiment shows blocks of functional units. Those functional blocks (structural components) can be realized by a desired combination of at least one of hardware and software. Means for realizing each functional block is not particularly limited. That is, each functional block may be implemented using a single physically or logically coupled device, or it may be implemented using two or more physically or logically separated devices connected directly or indirectly (For example, using wired, wireless, etc.). The functional block may be realized by combining the one apparatus or the plurality of apparatuses with software.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that functions transmission is called a transmission unit (transmitting unit) or a transmitter. As described above, the implementation method is not particularly limited.

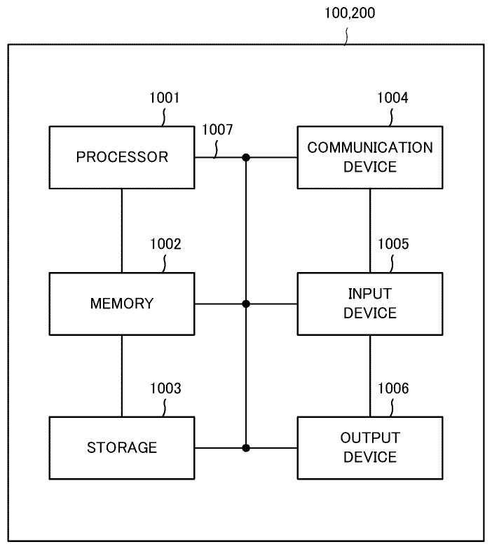

Furthermore, the above-described gNB100, UE200, and LMF300 (the apparatuses) may function as computers that perform the processing of the radio communication method of the present disclosure. FIG. 14 is a diagram showing an example of a hardware configuration of the apparatuses. As shown in FIG. 14, the apparatuses may be configured as computer apparatuses including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. The hardware configuration of the device may be configured to include one or more of the devices shown in the figures, or may be configured without some of the devices.

Each functional block of the device (see FIGS. 4 to 6) is implemented by any hardware element of the computer device, or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 controls the entire computer, for example, by running an operating system. The processor 1001 may be configured by a central processing unit (CPU) including interfaces with peripheral devices, controllers, arithmetic units, registers, etc.

Moreover, the processor 1001 reads a computer program (program code), a software module, data, and the like from the storage 1003 and/or the communication device 1004 into the memory 1002, and executes various processes according to the data. As the computer program, a computer program which is capable of executing on the computer at least a part of the operation explained in the above embodiments is used. Furthermore, the various processes described above may be performed by one processor 1001, or may be performed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory, or the like. The memory 1002 may store a program (program code), a software module, or the like capable of performing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (E.G., displays, speakers, LED lamps, etc.) for outputting to the outside. Note that, the input device 1005 and the output device 1006 may be integrated (for example, a touch screen).

The respective devices, such as the processor 1001 and the memory 1002, are connected by a bus 1007 for communicating information. The bus 1007 may be configured using a single bus or a different bus for each device.

Further, the device may be configured including hardware such as a microprocessor, a digital signal processor (DSP), an application specific integrated circuit (ASIC), a programmable logic device (PLD), a field programmable gate array (FPGA), or the like, by which some or all of the functional blocks are implemented. For example, the processor 1001 may be implemented by using at least one of these hardware.

Also, the notification of information is not limited to the aspects/embodiments described in this disclosure and may be performed using other methods. For example, the notification of information may be performed by physical layer signaling such as Downlink Control Information (DCI), Uplink Control Information (UCI), higher layer signaling (e.g., RRC signaling, Medium Access Control (MAC) signaling, broadcast information (Master Information Block (MIB), System Information Block (SIB)), other signals, or combinations thereof. The RRC signaling may also be referred to as an RRC message, for example, an RRC Connection Setup message, an RRC Connection Reconfiguration message, or the like.

Aspects/embodiments described in this disclosure include Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG) (x is, for example, an integer, a decimal), Future Radio Access (FRA), New Radio (NR), W-CDMA (R), GSM (R), CDMA2000, Ultra Mobile Broadband (UMB), IEEE 802.11 (Wi-Fi), IEEE 802.16 (WiMAX (R), IEEE 802.20, Ultra-WideBand (UWB), Bluetooth (R), It may be applied to at least one of systems utilizing other suitable systems and next generation systems extended thereon. Further, a plurality of systems may be combined (for example, a combination of at least one of the LTE and the LTE-A with the 5G).

The processing procedures, sequences, flowcharts, etc., of each aspect/embodiment described in the present disclosure may be reordered as long as there is no conflict. For example, the methods described in the present disclosure present the elements of the various steps using an exemplary order and are not limited to the particular order presented.

The specific operation performed by the base station in the present disclosure may be performed by its upper node in some cases. It will be apparent that in a network of one or more network nodes having base stations, various operations performed to communicate with a terminal may be performed by at least one of the base station and other network nodes other than the base station (Examples include, but are not limited to, MME or S-GW). In the above, an example in which there is one network node other than the base station is explained; however, a combination of a plurality of other network nodes (for example, MME and S-GW) may be used.

Information and signals (such as information) can be output from an upper layer (or lower layer) to a lower layer (or upper layer). It may be input and output via a plurality of network nodes.

The input/output information can be stored in a specific location (for example, a memory) or can be managed in a management table. Input and output information can be overwritten, updated, or appended. The information can be deleted after outputting. The inputted information can be transmitted to another device.

The determination may be made by a value represented by a single bit (0 or 1), by a true-false value (Boolean: true or false), or by a numeric comparison (E.G., comparison with a predetermined value).

Each of the aspects/embodiments described in this disclosure may be used alone, in combination, or alternatively as the implementation progresses. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when software is transmitted from a website, server, or other remote source using at least one of wired (Coaxial cable, fiber-optic cable, twisted pair, digital subscriber line (DSL), and so on.) and wireless (Infrared rays, microwaves, etc.) technologies, at least one of these wired and wireless technologies is included within the definition of the transmission medium.

Information, signals, or the like mentioned above may be represented by using any of a variety of different technologies. For example, data, instructions, commands, information, signals, bits, symbols, chips, etc. that may be referred to throughout the above description may be represented by voltages, currents, electromagnetic waves, magnetic fields or magnetic particles, light fields or photons, or any combination thereof.

Terms that have been described in this disclosure and that are necessary to understand this disclosure may be replaced with terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

A base station may accommodate one or more (For example, three) cells (also referred to as sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a portion or the entire coverage area of at least one of the base station and/or base station subsystems performing communication services in this coverage.

In this disclosure, the transmission of information by a base station to a terminal may be interpreted as the base station instructing the terminal to control and operate based on information.

In the present disclosure, the terms “mobile station (Mobile Station: MS),” “user terminal,” “user equipment (User Equipment: UE),” “terminal” and the like can be used interchangeablby.

A mobile station may also be referred to by those skilled in the art as a subscriber station, mobile unit, subscriber unit, wireless unit, remote unit, mobile device, wireless device, radio communications device, remote device, mobile subscriber station, access terminal, mobile terminal, wireless terminal, remote terminal, handset, user agent, mobile client, client, or some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, airplanes, etc.), an unmanned mobile unit (For example, drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

A base station in the present disclosure may also be read as a mobile station (user terminal, hereinafter the same). For example, each aspect/embodiment of the present disclosure may be applied to a configuration in which communication between the base station and the mobile station is replaced by communication between a plurality of mobile stations (For example, it may be called Device-to-Device (D2D), Vehicle-to-Everything (V2X), etc.). In this case, the mobile station may have the function of the base station. Further, words such as “up” and “down” may be read as words corresponding to communication between terminals (For example, “side”). For example, terms an uplink channel, a downlink channel, or the like may be read as a side channel.

Similarly, a mobile station in the present disclosure may be read as a base station. In this case, the base station may have the function of the mobile station.

A radio frame may be composed of one or more frames in the tie me domain. Each one or more frames in the time domain may be called a subframe.

A subframe may also be composed of one or more slots in the time domain. A subframe may have a fixed time length (For example, 1 ms) independent of numerology.

The numerology may be a communication parameter applied to at least one of the transmission and reception of a signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

A slot may be composed of one or more symbols in the time domain (Orthogonal Frequency Division Multiplexing (OFDM)) symbols, Single Carrier Frequency Division Multiple Access (SC-FDM-FDMA) symbols, etc. A slot may be a unit of time based on the numerology.

A slot may include a plurality of minisolots. Each minislot may be composed of one or more symbols in the time domain. A minislot may also be called a subslot. A minislot may be composed of fewer symbols than slots. PDSCH (or PUSCH) transmitted in time units greater than the minislot may be referred to as PDSCH (or PUSCH) Mapping Type A. PDSCH (or PUSCH) transmitted using the minislot may be referred to as PDSCH (or PUSCH) Mapping Type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called a TTI, and one slot or one minislot may be called a TTI. That is, at least one of the subframe and TTI may be a subframe (1 ms) in an existing LTE, a period (For example, 1-13 symbols) shorter than 1 ms, or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called a TTI, one or more TTIs (I.E., one or more slots or one or more minislots) may be the minimum time unit of scheduling. The number of slots (the number of minislots) constituting the minimum time unit of scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. A TTI shorter than the normal TTI may be called a shortened TTI, a short TTI, a partial TTI (partial or fractional TTI), a shortened subframe, a short subframe, a minislot, a subslot, a slot, or the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

A resource block (RB) is a resource allocation unit of a time domain and a frequency domain, and may include one or more consecutive subcarriers in the frequency domain. The number of subcarriers included in RB may be, for example, twelve, and the same regardless of the topology. The number of subcarriers included in the RB may be determined based on the numerology.

The time domain of the RB may include one or more symbols, and may be one slot, one minislot, one subframe, or one TTI in length. Each TTI, one subframe, or the like may comprise one or more resource blocks.

One or more RBs may be called a physical resource block (PRB), a sub-carrier group (SCG), a resource element group (REG), a PRB pair, an RB pair, or the like.

A resource block may be configured by one or more resource elements (RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RBs with reference to the common reference point of the carrier. PRB may be defined in BWP and numbered within that BWP.

BWP may include UL BWP (UL BWP) and DL BWP (DL BWP). For a UE, one or more BWPs may be configured in a carrier.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes contained in a radio frame, the number of slots per subframe or radio frame, the number of minislots contained in a slot, the number of symbols and RBs contained in a slot or minislot, the number of subcarriers contained in an RB, as well as the number of symbols, symbol length, cyclic prefix (CP) length, etc. in a TTI may vary.

The term “connected,” “coupled,” or any variation thereof, means any direct or indirect connection or connection between two or more elements, and may include the presence of one or more intermediate elements between two elements that are “connected” or “coupled” to each other. The connection or connection between elements may be physical, logical, or a combination thereof. For example, “connection” may be read as “access.” As used in the present disclosure, two elements may be considered to be “connected” or “coupled” to each other using at least one of one or more wires, cables and printed electrical connections, and by some non-limiting and non-exhaustive examples, electromagnetic energy having wavelengths in the radio frequency domain, microwave domain and optical (both visible and invisible) domain, etc.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to elements using designations such as “first,” “second,” etc. as used in this disclosure does not generally limit the amount or order of those elements. Such designations can be used in the present disclosure as a convenient way to distinguish between two or more elements. Thus, references to first and second elements do not imply that only two elements may be employed therein or that in any way the first element must precede the second element.

In the present disclosure, the used terms “include,” “including,” and variants thereof are intended to be inclusive in a manner similar to the term “comprising.” Furthermore, it is intended that the term “or” as used in this disclosure is not an exclusive OR.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judging” or “deciding” may include considering some action as having been “judged” or “decided.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

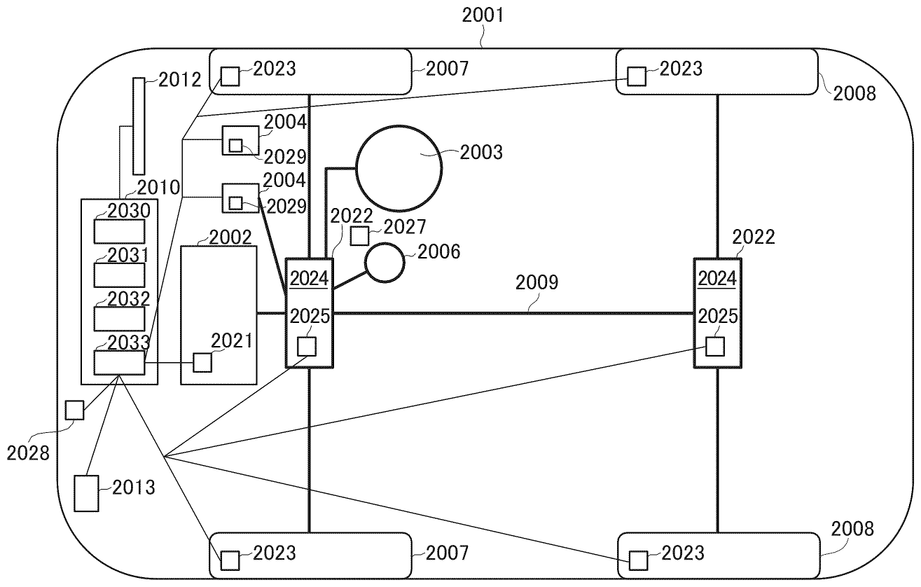

FIG. 15 shows a configuration example of vehicle 2001. As shown in FIG. 15, vehicle 2001 includes drive unit 2002, steering unit 2003, accelerator pedal 2004, brake pedal 2005, shift lever 2006, left and right front wheels 2007, left and right rear wheels 2008, axle 2009, electronic control unit 2010, various sensors 2021˜2029, information service unit 2012, and communication module 2013.

The drive unit 2002 is composed of, for example, an engine, a motor, and an engine-motor hybrid.

The steering unit 2003 includes at least a steering wheel and is configured to steer at least one of the front and rear wheels based on the operation of the steering wheel operated by the user.

The electronic control unit 2010 consists of a microprocessor 2031, a memory (ROM, RAM) 2032 and communication ports (IO ports) 2033. Signals from various sensors 2021˜2027 provided in the vehicle are input to electronic control unit 2010. The electronic control unit 2010 may be referred to as an ECU (Electronic Control Unit).

The signals from the various sensors 2021˜2028 include a current signal from a current sensor 2021 for sensing a current of a motor, a rotational speed signal of a front wheel and a rear wheel acquired by a rotational speed sensor 2022, an air pressure signal of a front wheel and a rear wheel acquired by an air pressure sensor 2023, a vehicle speed signal acquired by a vehicle speed sensor 2024, an acceleration signal acquired by an acceleration sensor 2025, a depressing amount signal of an accelerator pedal acquired by an accelerator pedal sensor 2029, a depressing amount signal of a brake pedal acquired by a brake pedal sensor 2026, an operation signal of a shift lever acquired by a shift lever sensor 2027, and a detection signal for detecting an obstacle, a vehicle, a pedestrian or the like acquired by an object detection sensor 2028.

information service unit 2012 is composed of various devices such as a car navigation system, an audio system, a speaker, a television, and a radio for providing various information such as driving information, traffic information, entertainment information, and the like, and one or more ECUs for controlling these devices. The information service unit 2012 provides various multimedia information and multimedia services to the occupants of the vehicle 2001 by utilizing information acquired from an external device via a communication module 2013 or the like.

A driver assistance system unit 2030 consists of various devices, such as millimeter-wave radar, LiDAR (Light Detection and Ranging), camera, positioning locator (e.g. GNSS), map information (e.g. high-definition (HD) maps, self-driving car (AV) maps, etc.), gyro system (e.g. IMU (Inertial Measurement Unit), INS (Inertial Navigation System), etc.), AI (Artificial Intelligence) chip, AI processor, which are used to provide functions to prevent accidents or reduce the driver's driving load, and one or more ECUs that control these devices. The driver assistance system unit 2030 also transmits and receives various information via the communication module 2013 to realize a driver assistance function or an automatic driving function.

The communication module 2013 can communicate with a microprocessor 2031 and components of the vehicle 2001 via a communication port. For example, communication module 2013 transmits and receives data to and from a microprocessor 2031, a memory (ROM, RAM) 2032, and a sensor 2021˜2028 in drive unit 2002, steering unit 2003, accelerator pedal 2004, brake pedal 2005, shift lever 2006, left and right front wheels 2007, left and right rear wheels 2008, axle 2009, and electronic control unit 2010 installed in vehicle 2001 through the communication port 2033.

The communication module 2013 is a communication device that can be controlled by the microprocessor 2031 of the electronic control unit 2010 and can communicate with external devices. For example, it transmits and receives various information to and from external devices via radio communication. The communication module 2013 may be either inside or outside the electronic control unit 2010. The external device may be, for example, a base station, a mobile station, etc.

communication module 2013 transmits a current signal from a current sensor input to electronic control unit 2010 to an external device through radio communication. communication module 2013 also transmits, to the external device via radio communication, the rotation speed signals of the front wheels and the rear wheels acquired by the rotation speed sensor 2022, the air pressure signals of the front wheels and the rear wheels acquired by the air pressure sensor 2023, the vehicle speed signals acquired by the vehicle speed sensor 2024, the acceleration signals acquired by the acceleration sensor 2025, the accelerator pedal depression amount signals acquired by the accelerator pedal sensor 2029, the brake pedal depression amount signals acquired by the brake pedal sensor 2026, the shift lever operation signals acquired by the shift lever sensor 2027, and the detection signals for detecting obstacles, vehicles, pedestrians, etc. acquired by the object detection sensor 2028, which are inputted to electronic control unit 2010.

The communication module 2013 receives various kinds of information (traffic information, signal information, Inter-vehicular distance information, etc.) transmitted from an external device and displays them to the information service unit 2012 provided in the vehicle. The communication module 2013 also stores various information received from external devices in the memory 2032 available by the microprocessor 2031. Based on the information stored in the memory 2032, the microprocessor 2031 may control drive unit 2002, steering unit 2003, accelerator pedal 2004, brake pedal 2005, shift lever 2006, left and right front wheels 2007, left and right rear wheels 2008, axle 2009, sensors 2021˜2028, etc. included in vehicle 2001.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### (Note)

The foregoing disclosure may be expressed as follows.

The first feature is a terminal comprising: a reception unit that receives two or more downlink reference signals at different timings on a time axis from a single non-terrestrial network device via a non-terrestrial network; and a control unit that controls a reporting of measurement results related to each of the two or more downlink reference signals in a specific control for estimating position information of the terminal based on the two or more downlink reference signals.

The second feature is the terminal in the first feature, wherein the measurement results include time information related to a basis reference signal which is one of the two or more downlink reference signals.

The third feature is the terminal in at least one of the first feature or the second feature, wherein the control unit performs the specific control by omitting a specific information element which is at least a part of information elements used in estimating the position information of the terminal using a terrestrial network.

The fourth feature is a base station comprising: a reception unit that receives two or more uplink reference signals at different timings on a time axis from a single non-terrestrial network device via a non-terrestrial network; and a control unit that controls a reporting of measurement results related to each of the two or more downlink reference signals in a specific control for estimating position information of the terminal based on the two or more downlink reference signals.

The fifth feature is the base station in the fourth feature, wherein the control unit performs the specific control by omitting a specific information element which is at least a part of information elements used in estimating the position information of the terminal using a terrestrial network.

The sixth feature is a radio communication system comprising: a terminal; and a base station; wherein at least one node of the terminal and the base station comprises: a reception unit that receives two or more uplink reference signals at different timings on a time axis from a single non-terrestrial network device via a non-terrestrial network; and a control unit that controls a reporting of measurement results related to each of the two or more downlink reference signals in a specific control for estimating position information of the terminal based on the two or more downlink reference signals.

The seventh feature is a radio communication method comprising: receiving two or more uplink reference signals at different timings on a time axis from a single non-terrestrial network device via a non-terrestrial network; and controlling porting of measurement results related to each of the two or more downlink reference signals in a specific control for estimating position information of the terminal based on the two or more downlink reference signals.

### EXPLANATION OF REFERENCE NUMERALS

10 Radio communication system
20 NG-RAN
30 Core network
100 gNB
100X NTN gateway
110 Reception unit
120 Transmission unit
130 Control unit
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
300 LMF
1001 Processor
1002 Memory
1003 Storage
1004 Communication device
1005 Input device
1006 Output device
1007 Bus
2001 Vehicles
2002 Drive
2003 Steering
2004 Axel pedal
2005 Brake pedal
2006 Schiff lever
2007 Left and right front wheels
2008 Right and left rear wheels
2009 Axles
2010 Electronic control unit
2012 Information service unit
2013 Communication module
2021 Current sensor
2022 Speed sensor
2023 Air pressure sensor
2024 Vehicle speed sensor
2025 Acceleration sensor
2026 Brake pedal sensor
2027 Shift lever sensor
2028 Object detection sensor
2029 Axel pedal sensor
2030 Operation support system section
2031 Microprocessor
2032 Memory (ROM, RAM)
2033 Communication port

1. A terminal comprising:
a reception unit that receives two or more downlink reference signals at different timings on a time axis from a single non-terrestrial network device via a non-terrestrial network; and
a control unit that controls a reporting of measurement results related to each of the two or more downlink reference signals in a specific control for estimating position information of the terminal based on the two or more downlink reference signals.

2. The terminal according to claim 1, wherein
the measurement results include time information related to a basis reference signal which is one of the two or more downlink reference signals.

3. The terminal according to claim 1, wherein
the control unit performs the specific control by omitting a specific information element which is at least a part of information elements used in estimating the position information of the terminal using a terrestrial network.

4. A base station comprising:
a reception unit that receives two or more uplink reference signals at different timings on a time axis from a single non-terrestrial network device via a non-terrestrial network; and
a control unit that controls a reporting of measurement results related to each of the two or more downlink reference signals in a specific control for estimating position information of the terminal based on the two or more downlink reference signals.

5. The base station according to claim 4, wherein
the control unit performs the specific control by omitting a specific information element which is at least a part of information elements used in estimating the position information of the terminal using a terrestrial network.

6. A radio communication system comprising:
a terminal; and
a base station; wherein
at least one node of the terminal and the base station comprises:
a reception unit that receives two or more uplink reference signals at different timings on a time axis from a single non-terrestrial network device via a non-terrestrial network; and
a control unit that controls a reporting of measurement results related to each of the two or more downlink reference signals in a specific control for estimating position information of the terminal based on the two or more downlink reference signals.

7. A radio communication method comprising:
receiving two or more uplink reference signals at different timings on a time axis from a single non-terrestrial network device via a non-terrestrial network; and
controlling porting of measurement results related to each of the two or more downlink reference signals in a specific control for estimating position information of the terminal based on the two or more downlink reference signals.
